(19) United States
(12) Patent Application Publication
(10) Pub. No.: US 2025/0226538 A1
(43) Pub. Date: Jul. 10, 2025

(54) CURRENT COLLECTOR FOR BATTERY CELL MODULE

(71) Applicant: GM GLOBAL TECHNOLOGY OPERATIONS LLC, DETROIT, MI (US)

(72) Inventors: Pushpendra Chauhan, San Jose, CA (US); Chinar S. Ghike, Farmington Hills, MI (US); Isabella Cureton, Northville, MI (US)

(21) Appl. No.: 18/408,101

(22) Filed: Jan. 9, 2024

(51) Int. Cl. H01M 50/503; H01M 50/159; H01M 50/512; H01M 50/55

(52) U.S. Cl. CPC H01M 50/503; H01M 50/159; H01M 50/512; H01M 50/55; H01M 2220/20

(57) ABSTRACT

A current collector of a battery assembly of a vehicle includes a plurality of contact plates. Each contact plate has a contactor at each end of the contact plate configured for electrical connection to a battery cell of a battery assembly. The plurality of contact plates are arranged to connect battery cells arranged along a same cell row of the battery assembly in parallel. A battery cell module of a vehicle includes a plurality of battery cells arranged in a plurality of cell rows, and a current collector assembly electrically connected to the plurality of battery cells and configured to direct a current flow from a first module terminal to a second module terminal. The first module terminal and the second module terminal are located at a same lateral side of the battery cell module.

### INTRODUCTION

The subject disclosure relates to vehicles, and in particular to rechargeable energy storage systems (RESS's) or battery systems, for vehicles.

RESS's are utilized to provide electrical energy to drive propulsion systems such as electric motors and/or other vehicle systems. The typical RESS contains a plurality of cell modules each containing a plurality of battery cells. The cell modules are electrically interconnected by a module-to-module buss via module terminals, and having these terminals located at a same lateral side of the module simplifies the buss arrangement. Electrical current is collected from the plurality of battery cells and directed between a first module terminal and a second module terminal via a current collector arrangement. To achieve the desired module terminal location, there should be an odd number of U-turns in the current flow along the current collector arrangement between the first module terminal and the second module terminal.

In a cylindrical battery cell module, it is typically preferred to have the number of cell rows be divisible by the P count of the cell module, where P count is defined as a number of battery cells in the cell module that are electrically connected in parallel. In some cases, however, due to other design constraints, such as, for example, battery cell size or available space for the cell module, the cell row count is not evenly divisible by the P count. Thus it is desired to provide a current collector arrangement that would simplify current collector arrangements and still provide the desired module terminal location, while also reducing current imbalance.

### SUMMARY

In one exemplary embodiment, a current collector of a battery assembly of a vehicle includes a plurality of contact plates. Each contact plate has a contactor at each end of the contact plate configured for electrical connection to a battery cell of a battery assembly. The plurality of contact plates are arranged to connect battery cells arranged along a same cell row of the battery assembly in parallel.

In addition to one or more of the features described herein at least one contactor arm extends between adjacent contact plates of the plurality of contact plates to electrically connect the adjacent contact plates.

In addition to one or more of the features described herein a cover plate is installed to at least one contact plate of the plurality of contact plates.

In addition to one or more of the features described herein the cover plate is formed from a first material and the contact plate is formed from a second material different from the first material.

In addition to one or more of the features described herein the cover plate is formed from a copper material.

In addition to one or more of the features described herein the plurality of contact plates are formed from an aluminum material.

In addition to one or more of the features described herein two adjacent contact plates of the plurality of contact plates are configured to electrically connect battery cells in the same cell row.

In another exemplary embodiment, a battery cell module of a vehicle includes a plurality of battery cells arranged in in a plurality of cell rows, and a current collector assembly electrically connected to the plurality of battery cells and configured to direct a current flow from a first module terminal to a second module terminal. The current collector assembly includes a plurality of contact plates. Each contact plate has a contactor at each end of the contact plate configured for electrical connection to a battery cell of a battery assembly. The plurality of contact plates are arranged to connect battery cells arranged along a same cell row of the battery assembly in parallel. The first module terminal and the second module terminal are located at a same lateral side of the battery cell module.

In addition to one or more of the features described herein at least one contactor arm extends between adjacent contact plates of the plurality of contact plates to electrically connect the adjacent contact plates.

In addition to one or more of the features described herein a cover plate is installed to at least one contact plate of the plurality of contact plates.

In addition to one or more of the features described herein the cover plate is formed from a first material and the contact plate is formed from a second material different from the first material.

In addition to one or more of the features described herein the cover plate is formed from a copper material.

In addition to one or more of the features described herein the plurality of contact plates are formed from an aluminum material.

In addition to one or more of the features described herein two adjacent contact plates of the plurality of contact plates are configured to electrically connect battery cells in the same cell row.

In yet another exemplary embodiment, a vehicle includes a vehicle body, a propulsion system to drive a movement of the vehicle, and a battery assembly operably connected to the propulsion system to power the propulsion system. The battery assembly includes a plurality of battery cells arranged in in a plurality of cell rows, and a current collector assembly electrically connected to the plurality of battery cells and configured to direct a current flow from a first module terminal to a second module terminal. The current collector assembly includes a plurality of contact plates. Each contact plate has a contactor at each end of the contact plate configured for electrical connection to a battery cell of a battery assembly. The plurality of contact plates are arranged to connect battery cells arranged along a same cell row of the battery assembly in parallel. The first module terminal and the second module terminal are positioned at a same lateral side of the battery cell module.

In addition to one or more of the features described herein at least one contactor arm extends between adjacent contact plates of the plurality of contact plates to electrically connect the adjacent contact plates.

In addition to one or more of the features described herein a cover plate is installed to at least one contact plate of the plurality of contact plates.

In addition to one or more of the features described herein the cover plate is formed from a first material and the contact plate is formed from a second material different from the first material.

In addition to one or more of the features described herein the cover plate is formed from a copper material and the plurality of contact plates are formed from an aluminum material.

In addition to one or more of the features described herein two adjacent contact plates of the plurality of contact plates are configured to electrically connect battery cells in the same cell row.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an exemplary embodiment of a vehicle;

FIG. 2 is a schematic illustration of an embodiment of an RESS of a vehicle;

FIG. 3 is an illustration of an exemplary embodiment of a current collector assembly; and

FIG. 4 is an illustration of an exemplary embodiment of a current collector module of a current collector assembly.

### DETAILED DESCRIPTION

The following description is merely exemplary in nature and is not intended to limit the present disclosure, its application or uses. It should be understood that throughout the drawings, corresponding reference numerals indicate like or corresponding parts and features.

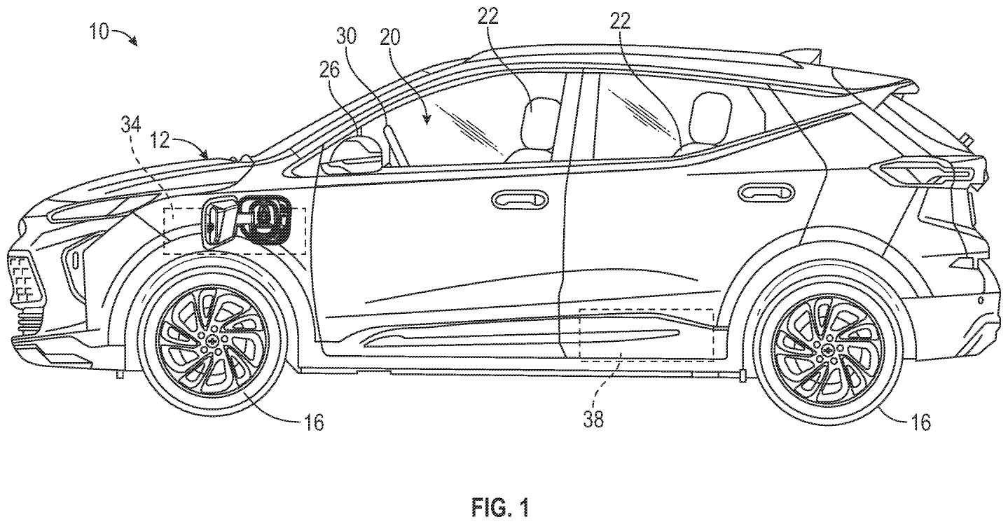

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes an electric motor 34 connected to a transmission that provides power to one or more of the plurality of wheels 16. A rechargeable energy storage system (RESS) or battery assembly 38 provides power to electric motor 34.

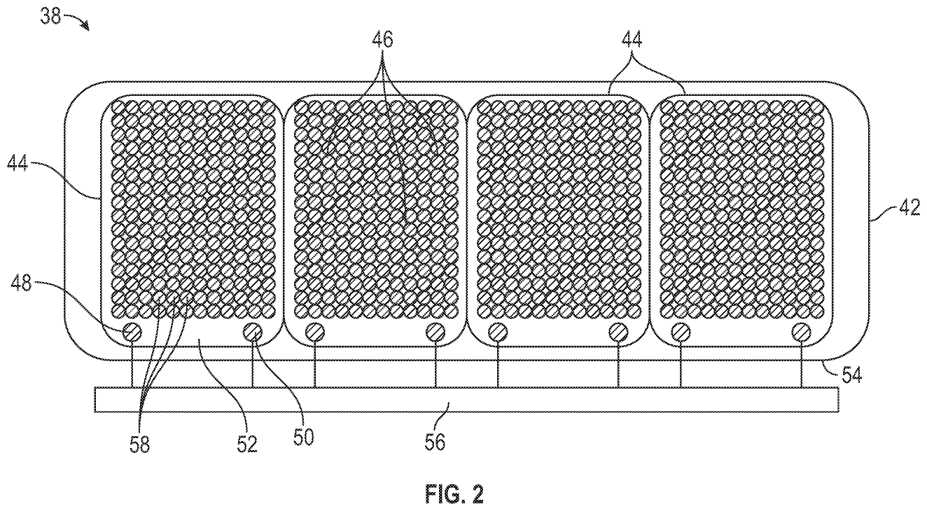

Referring now to FIG. 2, illustrated is an exemplary embodiment of a battery assembly 38. The battery assembly 38 includes a battery housing 42 with a plurality of cell modules 44 disposed therein. Each cell module 44 includes a plurality of battery cells 46 arranged and electrically interconnected therein. Each cell module 44 has a first module terminal 48 and a second module terminal 50 to communicate electrical current to and from the cell module 44. The first module terminal 48 and the second module terminal 50 are both located at the same module lateral side 52 of the cell module 44. Further, the cell modules 44 are arranged in the battery housing 42 such that all of the first module terminals 48 and the second module terminals 50 are located at the same assembly lateral side 54 of the battery assembly 38. The cell modules 44 are connected to the electric motor 34 via a battery buss 56.

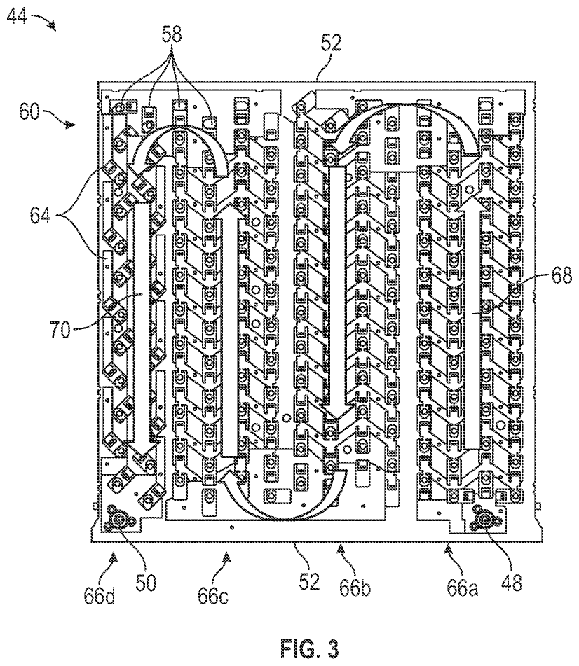

Referring now to FIG. 3, illustrated is an exemplary embodiment of a cell module 44. The cell module 44 includes a first module terminal 48 and a second module terminal 50 located at the same module lateral side 52 of the cell module 44. The cell module 44 includes a plurality of battery cells 46 arranged in a plurality of cell rows 58 (as best shown in FIG. 2). Each cell row 58 extends between the module lateral sides 52 of the cell module 44. The plurality of battery cells 46 are electrically interconnected by a current collector assembly 60 connected to cell terminals of the plurality of battery cells 46. The current collector assembly 60 is assembled from a plurality of current collector modules 64 that are configured based on the arrangement of battery cells 46 and cell rows 58 in the cell module 44 to electrically interconnect the battery cells 46 so current is directed from the first module terminal 48 to the second module terminal 50.

To achieve this, the cell module 44 is typically arranged in a plurality of sectors 66 corresponding to a number of cell rows 58. For example, in the embodiment of FIG. 3 a first sector 66a corresponds to cell rows 1-4 of the cell module 44. A second sector 66b corresponds to cell rows 5-8 of the cell module 44, and a third sector 66c corresponds to cell rows 9-12 of the cell module 44. Finally, a fourth sector 66d corresponds to cell rows 13 and 14 of the cell module 44. The collector modules 64 are arranged such that electrical current flows from the first module terminal 48 along the cell rows 58 of the first sector 66a in a first direction 68. The electrical current then flows along the cell rows 58 of the second sector 66b in a second direction 70 opposite the first direction 68. From the second sector 66b, the electrical current then flows along the cell rows 58 of the third sector 66c in the first direction 68 and along the cell rows 58 of the fourth sector 66d in the second direction 70 to the second module terminal 50. The current collector modules 64 are connected such that the flow of electrical current performs a U-turn or reverses direction between adjacent sectors 66a, 66b, 66c and 66d. This arrangement results in a “4P” configuration, with four battery cells 46 grouped and connected in an electrically parallel relationship, and these groups of four battery cells 46 connected to each other in an electrically serial relationship.

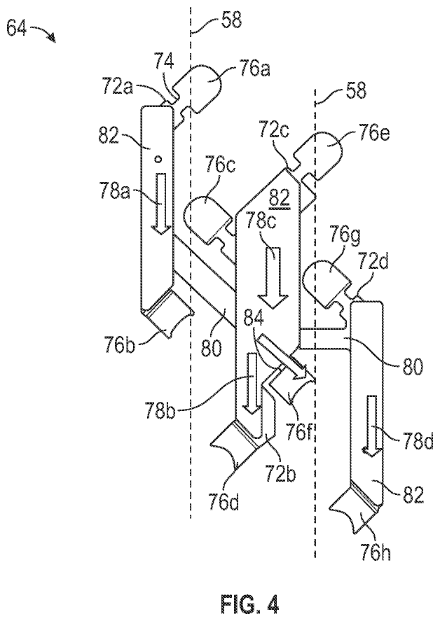

An exemplary embodiment of a current collector module 64 is illustrated in FIG. 4. The current collector module 64 is configured to interconnect eight cell terminals of the plurality of battery cells 46 and defines a plurality of current pathways therethrough. In the embodiment of FIG. 4, the current collector module 64 extends along and interconnects battery cells 46 of two adjacent cell rows 58, interconnecting 4 battery cells 46 in each of two adjacent cell rows 58. The current collector module 64 includes a plurality of contact plates 72 that include contactors at contact plate ends 74 defining contactors 76 for connection to the battery cells 46. As illustrated in FIG. 4, a first contact plate 72a connects and defines a first current pathway 78a between a first contactor 76a and a second contactor 76b. A second contact plate 72c defines a second current pathway 78c between a contactors 76c and 76e to contactors 76d and 76f. Contact plate arm 72b and notch 84 equally splits current pathway 78c into current pathway 78b flowing to contactor 76d and current pathway 78e flowing to contactor 76f. A fourth contact plate 72d connects and defines a fourth current pathway 78d between a seventh contactor 76g and an eighth contactor 76h. This connection arrangement results in contactors 76a, 76c, 76e and 76g being grouped in a parallel relationship and contactors 76b, 76d, 76f, and 76h being similarly grouped in a parallel relationship. These two groups are arranged in series with each other, even though spatially the corresponding battery cells 46 are arranged in two rows. The configurations and arrangements described herein advantageously prevent current imbalances along the current pathways, providing for a structure that encourages an even and balanced current flow along the current pathways.

The contact plates 72 and the contactors 76 are arranged such when installed into the plurality of battery cells 46, the contactors 76a, 76b, 76c and 76d all are connected to battery cells 46 of a first cell row 48 and the contactors 76e, 76f, 76g, and 76h all are connected to battery cells 46 of a second cell row 48 adjacent to the first cell row 48. In some embodiments, the contact plates 72a, 72c, and 72d are interconnected via one or more contactor arms 80 extending between adjacent contact plates 72. The use of the contactor arms 80 enables the contact plates 72a, 72c, and 72d to be manufactured as a single piece. The cross-sectional size of contactor arms 80 is kept low to minimize cross-flow of current between 78a, 78c and 78d.

The contact plates 72 are formed from, for example an aluminum material for conduction of electrical current therethrough, and in some embodiments the current collector module 64 may be a two-piece structure having an aluminum base contact plate 72 and a cover plate 82 formed from, for example, a copper material, disposed over the contact plate 72. Inclusion of the cover plate 82 in the current collector module structure 64 preferentially directs the flow of electric current along the contact plates 72. Further, in some embodiments the cover plate 82 has a larger cross-section than the contactor arms 80 to also preferentially direct the flow of electric current along the contact plates 72 and in the desired direction toward the module terminal.

The exemplary embodiments illustrated and described herein relate to a 4P cell module 44, but one skilled in the art will readily appreciate that the disclosed embodiment and structure may be readily adapted to cell modules having other P-counts, for example, 6P or 8P structures.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A current collector of a battery assembly of a vehicle, comprising:
a plurality of contact plates, each contact plate having a contactor at each end of the contact plate configured for electrical connection to a battery cell of a battery assembly;
wherein the plurality of contact plates are arranged to connect battery cells arranged along a same cell row of the battery assembly in parallel.

2. The current collector of claim 1, further comprising at least one contactor arm extending between adjacent contact plates of the plurality of contact plates to electrically connect the adjacent contact plates.

3. The current collector of claim 1 further comprising a cover plate installed to at least one contact plate of the plurality of contact plates.

4. The current collector of claim 3, wherein the cover plate is formed from a first material and the contact plate is formed from a second material different from the first material.

5. The current collector of claim 3, wherein the cover plate is formed from a copper material.

6. The current collector of claim 1, wherein the plurality of contact plates are formed from an aluminum material.

7. The current collector of claim 1, wherein two adjacent contact plates of the plurality of contact plates are configured to electrically connect battery cells in the same cell row.

8. A battery cell module of a vehicle, comprising:
a plurality of battery cells arranged in in a plurality of cell rows; and
a current collector assembly electrically connected to the plurality of battery cells and configured to direct a current flow from a first module terminal to a second module terminal, the current collector assembly including:
a plurality of contact plates, each contact plate having a contactor at each end of the contact plate configured for electrical connection to a battery cell of a battery assembly;
wherein the plurality of contact plates are arranged to connect battery cells arranged along a same cell row of the battery assembly in parallel; and
wherein the first module terminal and the second module terminal are disposed at a same lateral side of the battery cell module.

9. The battery cell module of claim 8, further comprising at least one contactor arm extending between adjacent contact plates of the plurality of contact plates to electrically connect the adjacent contact plates.

10. The battery cell module of claim 8, further comprising a cover plate installed to at least one contact plate of the plurality of contact plates.

11. The battery cell module of claim 10, wherein the cover plate is formed from a first material and the contact plate is formed from a second material different from the first material.

12. The battery cell module of claim 10, wherein the cover plate is formed from a copper material.

13. The battery cell module of claim 8, wherein the plurality of contact plates are formed from an aluminum material.

14. The battery cell module of claim 8, wherein two adjacent contact plates of the plurality of contact plates are configured to electrically connect battery cells in the same cell row.

15. A vehicle comprising:
a vehicle body;
a propulsion system to drive a movement of the vehicle; and
a battery assembly operably connected to the propulsion system to power the propulsion system, the battery assembly including:
a plurality of battery cells arranged in in a plurality of cell rows; and
a current collector assembly electrically connected to the plurality of battery cells and configured to direct a current flow from a first module terminal to a second module terminal, the current collector assembly including:
a plurality of contact plates, each contact plate having a contactor at each end of the contact plate configured for electrical connection to a battery cell of a battery assembly;
wherein the plurality of contact plates are arranged to connect battery cells arranged along a same cell row of the battery assembly in parallel;
wherein the first module terminal and the second module terminal are disposed at a same lateral side of the battery assembly.

16. The vehicle of claim 15, further comprising at least one contactor arm extending between adjacent contact plates of the plurality of contact plates to electrically connect the adjacent contact plates.

17. The vehicle of claim 15, further comprising a cover plate installed to at least one contact plate of the plurality of contact plates.

18. The vehicle of claim 17, wherein the cover plate is formed from a first material and the contact plate is formed from a second material different from the first material.

19. The vehicle of claim 17, wherein the cover plate is formed from a copper material and the plurality of contact plates are formed from an aluminum material.

20. The vehicle of claim 15, wherein two adjacent contact plates of the plurality of contact plates are configured to electrically connect battery cells in the same cell row.
